(19) United States
(12) Patent Application Publication
(10) Pub. No.: US 2006/0171168 A1
(43) Pub. Date: Aug. 3, 2006

(54) Light guiding system

(76) Inventors: Ming-Tsung Cheng, Kweishan (TW); Tzu-Hsuan Lan, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/318,973

(22) Filed: Dec. 27, 2005

(30) Foreign Application Priority Data
Dec. 27, 2004 (TW) 093140789

(51) Int. Cl. F21V 7/04

(52) U.S. Cl. 362/628

(57) ABSTRACT

A light guiding system is provided. The light guiding system has an optical axis and a horizontal axis perpendicular to the optical axis. The light guiding system includes N first light guiding units, N second light guiding units, a first light source set, and a second light set. The first light source set is disposed at one side of the optical axis and provides a first light. The second light source set is disposed at the other side of the optical axis and provides a second light. The first and second light guiding units are disposed in an interlaced manner such that the combination of the first light and the second light has a uniform lightness along the horizontal axis.

### BACKGROUND OF THE INVENTION

1. Field of the Invention

This invention relates to a light guiding system. More specifically, the invention relates to a light guiding system that can outputs uniform light.

2. Description of the Prior Art

In prior optical projection systems, lights are filtered with a light guiding plate for reducing light noises and providing lights which are uniform in direction and energy. However, in an optical projection system with light guiding plates, the strength of lights decreases at many places, for example, light guiding plates, light polarizing plates, and reflectors, during the process of projecting lights. Therefore, how to utilize light sources effectively and raise strengths of lights is important.

Many methods for improving lightness in optical projection systems have been tried. Most of the methods aim at reforming light sources or light guiding plates, for example, adding the amount of light sources, adding the power of a light source, or changing the angle or material of light guiding plates.

Please refer to FIG. 1A. FIG. 1A shows a light guiding plate 10 and a light source 12 according to prior arts. The distances between different positions on the light guiding plate 10 and the light source 12 are different from each other. Generally, it is darker at the positions farther from the light source 12. The outline of the light guiding plate 10 is changeful for adjusting the lightness of the output light 14 corresponding to each position on the light guiding plate 10.

The outline of a light guiding plate in prior arts is designed according to the position of the light source. Once additional light sources are added for increasing lightness, the light guiding plate must be re-designed to provide lights with correct direction and energy. If additional light sources are added but the light guiding plate is not properly re-designed, the lightness might not be actually increased.

Please refer to FIG. 1B. FIG. 1B shows the relationship between lightness and distances from a light source in prior arts. As shown in FIG. 1B, the lightness of the output light 14 is not uniform in this light guiding system; the lightness of the output light 14 is stronger at positions closer to the light source 12 and weaker at positions farther from the light source 12.

Accordingly, the main purpose of this invention is providing a light guiding system to overcome the aforementioned problem.

### SUMMARY OF THE INVENTION

One main purpose of this invention is providing a light guiding system which provides larger lightness than prior arts.

The other main purpose of this invention is providing a light guiding system which provides lights with uniform lightness.

A light guiding system of one embodiment according to this invention has an optical axis and a horizontal axis perpendicular to the optical axis. The light guiding system includes N first light guiding units, N second light guiding units, a first light source set, and a second light set. N is a natural number. Each first light guiding unit respectively has a first incident surface and a first light guiding surface. Each first light guiding unit is disposed along the horizontal axis. Each second light guiding unit respectively has a second incident surface and a second light guiding surface. Each second light guiding unit is disposed along the horizontal axis. The N first light guiding units and the N second light guiding units are disposed in an interlaced manner. The first light source set is disposed at one side of the first incident surfaces. The first light source set provides a first light so that after being provided on the first incident surfaces, the first light is projected to the first light guiding surfaces and then proceeds along the optical axis. The second light source set is disposed at one side of the second incident surfaces. The second light source set provides a second light so that after being provided on the second incident surfaces, the second light is projected to the second light guiding surfaces and then proceeds along the optical axis. In this light guiding system, the strengths of the first light and the second light substantially compensate each other along the horizontal axis.

With the plural light sources and the plural light guiding units disposed in an interlaced manner, the light guiding system provides lights with uniform lightness along the horizontal axis. The advantage and spirit of the invention may be understood by the following recitations together with the appended drawings.

### BRIEF DESCRIPTION OF THE APPENDED DRAWINGS

FIG. 1A shows a light guiding plate 10 and a light source 12 in prior arts.

FIG. 1B shows the relationship between the lightness and the distance from the light source in prior arts.

FIG. 2A is the block diagram of the light guiding system according to this invention.

FIG. 2B shows the relationship between the lightness along the horizontal axis and the distance from the light source in the light guiding system according to this invention.

FIG. 3 shows the light guiding system of another embodiment according to this invention.

### DETAILED DESCRIPTION OF THE INVENTION

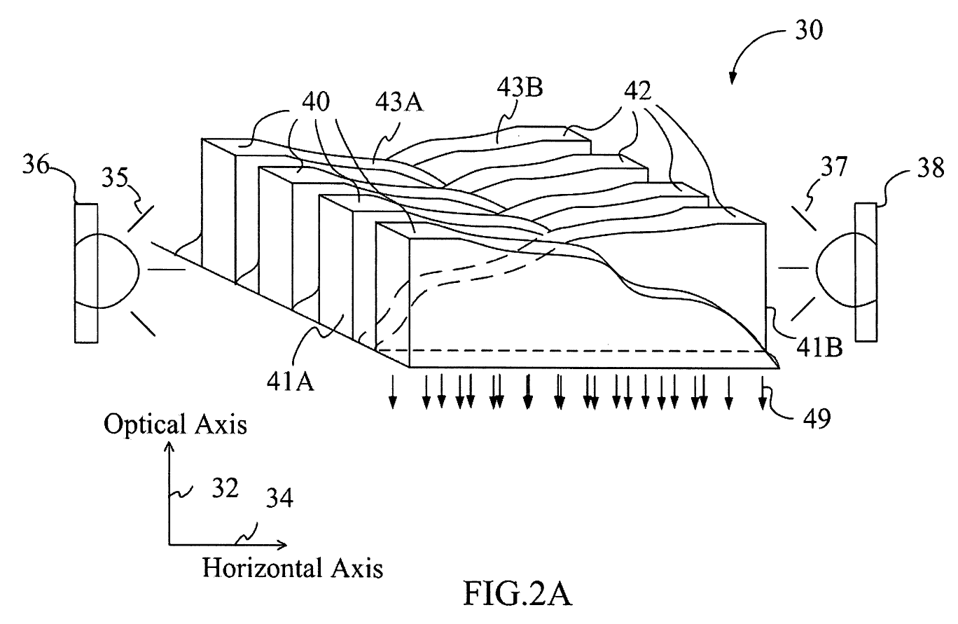

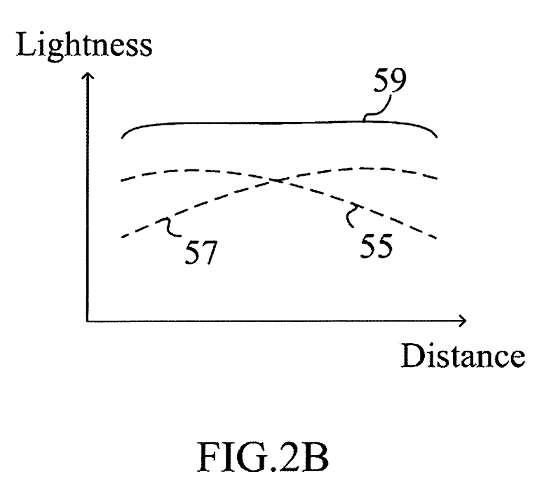

Please refer to FIG. 2A. FIG. 2A shows the block diagram of the light guiding system 30 of one embodiment according to this invention. The light guiding system 30 has an optical axis 32 and a horizontal axis 34 perpendicular to the optical axis 32. The light guiding system 30 includes a first light source set 36, a second light set 38, N first light guiding units 40, and N second light guiding units 42. N is a natural number.

Each first light guiding unit 40 respectively has a first incident surface 41A and a first light guiding surface 43A. Each first light guiding unit 40 is disposed along the horizontal axis 34. Each second light guiding unit 42 respectively has a second incident surface 41B and a second light guiding surface 43B. Each second light guiding unit 42 is also disposed along the horizontal axis 34. As shown in FIG. 2A, the N first light guiding units 40 and the N second light guiding units 42 are disposed in an interlaced manner.

The first light source set 36 is disposed at one side of the first incident surfaces 41A. The first light source set 36 provides a first light 35 so that after being provided on the first incident surfaces 41A, the first light 35 is projected to the first light guiding surfaces 43A and then proceeds along the optical axis 32.

The second light source set 38 is disposed at one side of the second incident surfaces 41B. The second light source set 38 provides a second light 37 so that after being provided on the second incident surfaces 41B, the second light 37 is projected to the second light guiding surfaces 43B and then proceeds along the optical axis 32.

Along the horizontal axis 34, the strengths of the first light 35 and the second light 37 substantially compensate each other.

In actual applications, each first light guiding surface 43A of the N first light guiding units 40 has a specific outline. The height of each first light guiding unit 40 along the optical axis 32 is irregular. The height of each first light guiding unit 40 at the side closer to the first light source set 36 is larger than that at the side farther from the first light source set 36. Each first light guiding surface 43A of the first light guiding units 40 is oblique along the horizontal axis 34. Similarly, each second light guiding surface 43B of the N second light guiding units 42 has a specific outline. The height of each second light guiding unit 42 along the optical axis 32 is irregular. The height of each second light guiding unit 42 at the side closer to the second light source set 38 is larger than that at the side farther from the second light source set 38. Each second light guiding surface 43B of the second light guiding units 42 is oblique along the horizontal axis 34.

With the two light sources and the plural light guiding units, the light guiding system 30 provides a output light 49 with uniform lightness along the horizontal axis 34, wherein the output light 49 is formed with the first light 35 and the second light 37.

In actual applications, each light guiding unit of the first light guiding units 40 and the second light guiding units 42 can be a light guiding plate or a reflector.

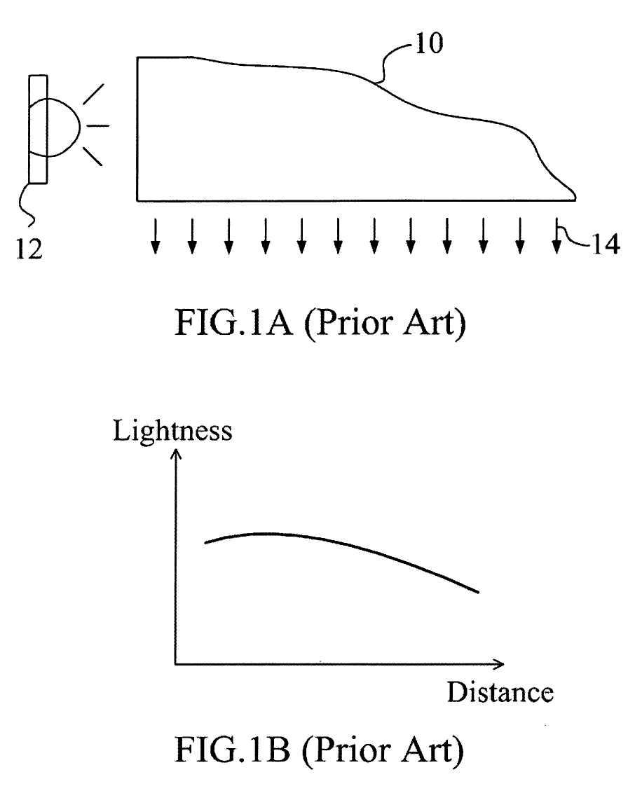

Please refer to FIG. 2B. FIG. 2B shows the relationship between the lightness along the horizontal axis 34 and the distance from the light source in the light guiding system 30 according to this invention. In FIG. 2B, the curve 55 shows the lightness of the first light 35 at different distances from the first light source 36, and the curve 57 shows the lightness of the second light 37 at different distances from the second light source 38. The curve 59 shows the combination of the curve 55 and the curve 57. As shown in FIG. 2B, the lightness of the output light 49 is almost uniform along the horizontal axis 34 and unaffected by the factor of distance. Therefore, the light guiding system 30 according to this invention can solve the problem of un-uniform lightness as shown in FIG. 1A and FIG. 1B.

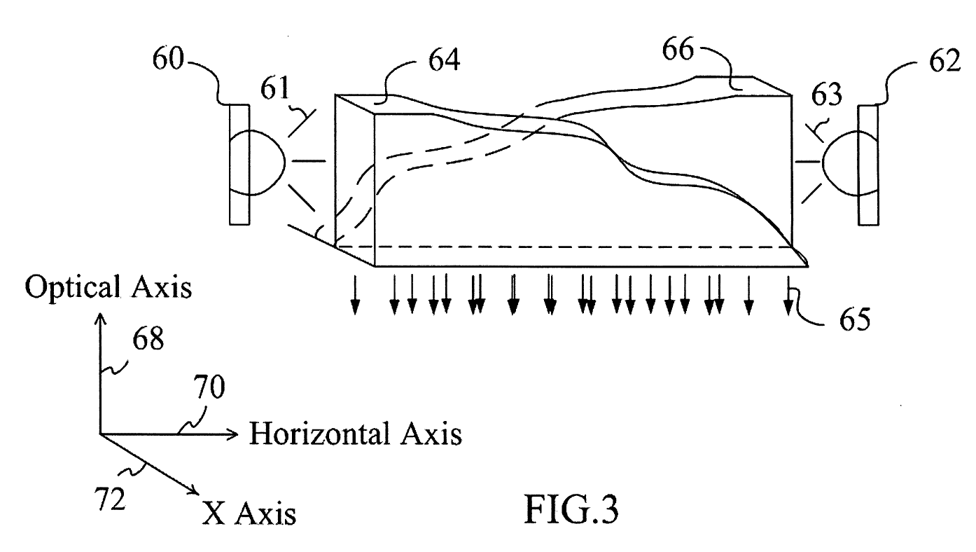

Please refer to FIG. 3. FIG. 3 shows the light guiding system 60 of another embodiment according to this invention. In this embodiment, the light guiding system 60 includes a first light source set 62, a second light source set 64, a first light guiding unit 66, and a second light guiding unit 68. The second light guiding unit 68 is the same as the first light guiding unit 66. With the first light guiding unit 66 and the second light guiding unit 68, the strengths of the first light 61 and the second light 63 substantially compensate each other along the horizontal axis 72 and form a output light 65, that is to say, the lightness of the output light 65 is uniform along the horizontal axis 72.

Although the light guiding system 60 can provide lights with uniform lightness as the light guiding system 30, the lightness of the output light 65 along the X axis must be further adjusted so that the lightness of the output light 65 can also be uniform along the X axis. The light guiding system 30 is a preferred embodiment according to this invention because the light guiding system 30 can provide output lights uniform in both the horizontal axis and the X axis. The light guiding system according to this invention uses the second light source set symmetric to the first light source set to provide abundant lightness. Besides, the first light guiding units and the second light guiding units are disposed in an interlaced manner such that lights with uniform lightness can be provided. Hence, the light guiding system according to this invention has better effectiveness than the light guiding systems in prior arts.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A light guiding system having an optical axis and a horizontal axis perpendicular to the optical axis, said system comprising:
N first light guiding units, N being a natural number, each first light guiding unit respectively having a first incident surface and a first light guiding surface, and each first light guiding unit being disposed along the horizontal axis;
N second light guiding units, each second light guiding unit respectively having a second incident surface and a second light guiding surface, and each second light guiding unit being disposed along the horizontal axis;
a first light source set disposed at one side of the first incident surfaces, the first light source set providing a first light so that after being provided on the first incident surfaces, the first light is projected to the first light guiding surfaces and then proceeds along the optical axis; and
a second light source set disposed at one side of the second incident surfaces, the second light source set providing a second light so that after being provided on the second incident surfaces, the second light is projected to the second light guiding surfaces and then proceeds along the optical axis,
wherein along the horizontal axis, the strengths of the first light and the second light substantially compensate each other, and the N first light guiding units and the N second light guiding units are disposed in an interlaced manner.

2. The light guiding system of claim 1, wherein each first light guiding surface and each second light guiding surface respectively has a specific outline, the heights of the first light guiding units and the second light guiding units are irregular, the heights of the first light guiding units at the side closer to the first light source set is larger than that at the side farther from the first light source set, and the heights of the second light guiding units at the side closer to the second light source set is larger than that at the side farther from the second light source set.

3. The light guiding system of claim 2, wherein each first light guiding unit is substantially oblique, and the first light guiding surfaces and the second light guiding surfaces are oblique along the horizontal axis.

4. The light guiding system of claim 1, wherein each first light guiding unit is a light guiding plate.

5. The light guiding system of claim 1, wherein each second light guiding unit is a light guiding plate.

6. The light guiding system of claim 1, wherein each first light guiding unit is a reflector.

7. The light guiding system of claim 1, wherein each second light guiding unit is a reflector.
